(19) United States
(12) Patent Application Publication
(10) Pub. No.: US 2005/0127677 A1
(43) Pub. Date: Jun. 16, 2005

(54) Roadway generating electrical power by incorporating piezoelectric materials

(76) Inventor: Jeffrey K. Luttrull, Ojai, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/995,991

(22) Filed: Nov. 22, 2004

Related U.S. Application Data
(60) Provisional application No. 60/526,830, filed on Dec. 3, 2003.

(51) Int. Cl. H02P 9/04

(52) U.S. Cl. 290/1 R; 310/339

(57) ABSTRACT

A process for generating electricity from vehicular traffic includes distributing a plurality of piezoelectric elements no higher than an adjacent surface of a roadway. Electric current is generated as traffic passes over the roadway, and the electric current conducted away from the piezoelectric elements to provide the electrical current for consumption.

### RELATED APPLICATION

This application claims priority to U.S. Provisional Application Ser. No. 60/526,830, filed on Dec. 3, 2003.

### BACKGROUND OF THE INVENTION

The invention relates generally to an electrical generating system. More particularly, the present invention relates to an electrical generating system incorporating piezoelectric materials into a roadway.

There is a great need for efficient devices to generate electricity from the movement of vehicular traffic over a roadway.

Many different types of mechanical, hydraulic, and other systems have been proposed to achieve electrical generation from roadways. However, such systems have their limitations, as described above and as follows. For example, U.S. Pat. No. 3,885,163 discloses an expressway power generating system. However, this system relies on the use of rollers which are subject to mechanical wear, breakdown and require maintenance. In another example, U.S. Pat. No. 4,239,974 discloses an electrical power generating system. However, this system relies on the use of vibrational transducers which are also subject to mechanical wear, breakdown and require maintenance. Other prior art systems are also impractical for one or all of the following factors: expense of manufacture and installation; complexity; durability; required level of maintenance; inefficiency; and compromise of basic roadway function.

While devices such as the ones described above may provide means of generating electricity, such devices can always be improved.

Accordingly, there is a need for an electrical generating system incorporated into a roadway that reduces expense of manufacture and installation. There is a further need for an electrical generating system incorporated into a roadway that reduces complexity and provides increased durability. There is an additional need for an electrical generating system incorporated into a roadway that reduces the level of maintenance required for mechanical systems. There is also a need for an electrical generating system incorporated into a roadway that avoids compromising the basic roadway function. The present invention satisfies these needs and provides other related advantages.

### SUMMARY OF THE INVENTION

The present invention provides an electrical generating system incorporated into a roadway that reduces expense of manufacture and installation. The present invention further provides an electrical generating system incorporated into a roadway that reduces complexity and provides increased durability. The present invention additionally provides for an electrical generating system incorporated into a roadway that reduces the level of maintenance required for mechanical systems. The present invention also provides an electrical generating system incorporated into a roadway that avoids compromising the basic roadway function.

A process for generating electricity from vehicular traffic includes distributing a plurality of piezoelectric elements no higher than an adjacent surface of a roadway. Electric current is generated as traffic passes over the roadway, and the electric current conducted away from the piezoelectric elements to provide the electrical current for consumption.

The process includes embedding the piezoelectric elements under the surface. Whether located at the surface or embedded under the surface, the piezoelectric elements are arranged across a flow of traffic.

As part of generating the electric current, the piezoelectric elements are deformed to create the electric current. The generation of electric current occurs without moving parts.

The piezoelectric elements are selected from a variety of types such as wires, strips, cables (sheathed or unsheathed). These piezoelectric elements are shaped to maximize their deformable surface area. The piezoelectric elements are shaped to provide more deformable surface area than a straight piezoelectric element. Other types of piezoelectric elements includes plates. The piezoelectric elements may be coated with a piezoelectric film or the piezoelectric element may comprise a piezoelectric film that is used to coat the surface of the roadway.

The process includes the preparation of the surface as part of a piezoelectric roadway segment which can be incorporated into the roadway wherein the segment is level with the roadway.

Additionally, piezoelectric elements are incorporated within structures that support the roadway and generate electric current from the repetitive stresses upon those structures.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an orthogonal view of several methods of enhancing PE deflection/stress/deformation/compression embodying the present invention;

FIG. 2 is an orthogonal view of an embodiment of a PE material incorporated into a roadway embodying the present invention;

FIG. 3 is an orthogonal view of an additional embodiment of a PE material incorporated into a roadway embodying the present invention;

FIG. 4 is an orthogonal view of a further embodiment of a PE material incorporated into a roadway embodying the present invention;

FIG. 5 is an orthogonal view of another embodiment of a PE material incorporated into a roadway embodying the present invention;

FIG. 6 is an orthogonal view of yet another embodiment of a PE material incorporated into a roadway embodying the present invention;

FIG. 7 is an orthogonal view of still another embodiment of a PE material incorporated into a roadway embodying the present invention;

FIG. 8 is an orthogonal view of an even further embodiment of a PE material incorporated into a roadway embodying the present invention;

FIG. 9 is an orthogonal view of one more embodiment of a PE material incorporated into a roadway embodying the present invention;

FIG. 10 is an orthogonal view of still one more embodiment of a PE material incorporated into a roadway embodying the present invention;

FIG. 11 is an orthogonal view of a further embodiment of a PE material incorporated into a roadway embodying the present invention;

FIG. 12 is an orthogonal view of yet one more additional embodiment of a PE material incorporated into a roadway embodying the present invention; and

FIG. 13 is an orthogonal view of yet an additional embodiment of a PE material incorporated into a roadway embodying the present invention.

### DETAILED DESCRIPTION OF THE PREFERRED EMBODIMENT

The present invention is useful in a variety of applications where movement over a surface can be used to generate electrical power through the use of PE materials. The present invention incorporates an electrical generating system into a roadway that reduces expense of manufacture and installation. The present invention incorporates an electrical generating system into a roadway that reduces complexity and provides increased durability. The present invention incorporates an electrical generating system into a roadway that reduces the level of maintenance required. The present invention incorporates an electrical generating system into a roadway that avoids compromising the basic roadway function. The present invention illustrates how piezoelectric conversion of the movement of vehicular traffic transforms a high frequency, high traffic density roadway into an electrical generating system.

Many urban metropolitan areas include large-scale roadway infrastructure, such as freeway systems, designed to accommodate personal automobiles, buses, trucks, motorcycles and various other vehicular traffic. In many urban areas, such roadway systems are congested by seemingly ever-increasing high-density vehicle traffic around the clock, throughout the year.

Motor vehicles are propelled by internal combustion engines which burn increasingly scarce and expensive fossil fuel. The energy efficiency of motor vehicles is extremely low. Most of the kinetic energy of the vehicle in motion, and the potential energy in its mass, often in excess of 5,000 kilograms, is unrealized and wasted. The present invention harnesses the energy wasted during the movement of a motor vehicle over a roadway surface and uses high frequency, high density vehicular traffic to generate electrical power.

The term Piezoelectric Effect (PE) describes a physical phenomenon whereby application of electrical current to certain crystalline structures results in physical deformation of the crystalline structure. The reverse of this phenomenon is also observed: that stressing or deforming certain crystalline structures results in the generation of electrical current.

The current applications of PE technology are common and varied. There are many types of piezoelectric materials and systems which, with improvements in technology, become more varied, efficient, and inexpensive with each passing day.

Piezoelectric materials, incorporated into roadway systems, can generate electrical energy for popular consumption. Such piezoelectric materials can be applied or embedded into existing roadways. Piezoelectric materials can also be incorporated into the construction of new roads making such piezoelectric materials as durable as the roadway itself.

The method of construction and incorporation of piezoelectric materials into the roadway could be chosen not only to minimize cost and maintenance, and maximize durability, but also to enhance the electrical current generating efficiency of the system. For example, large plate-like piezoelectric elements or roadway segments might be practical and efficient. Alternatively, power generation might be increased by incorporation or application of many small piezoelectric elements, such as networked “wires”, films or strips, into the roadway. The current generated by each would be multiplied by the number of vehicles passing over, and doubled or more by the number of axles/wheels from each vehicle contacting each piezoelectric element. The summation of these otherwise small amounts of electrical current thus generated and collected are significant. Anticipating high durability and low maintenance due to the nature of the materials, construction, and absence of moving parts, with reasonable cost of manufacture and installation, a piezoelectric-based electrical generating system incorporated into a high frequency/high density urban metropolitan roadway system produces a significant and reliable source of electrical power for municipal consumption at a low marginal cost.

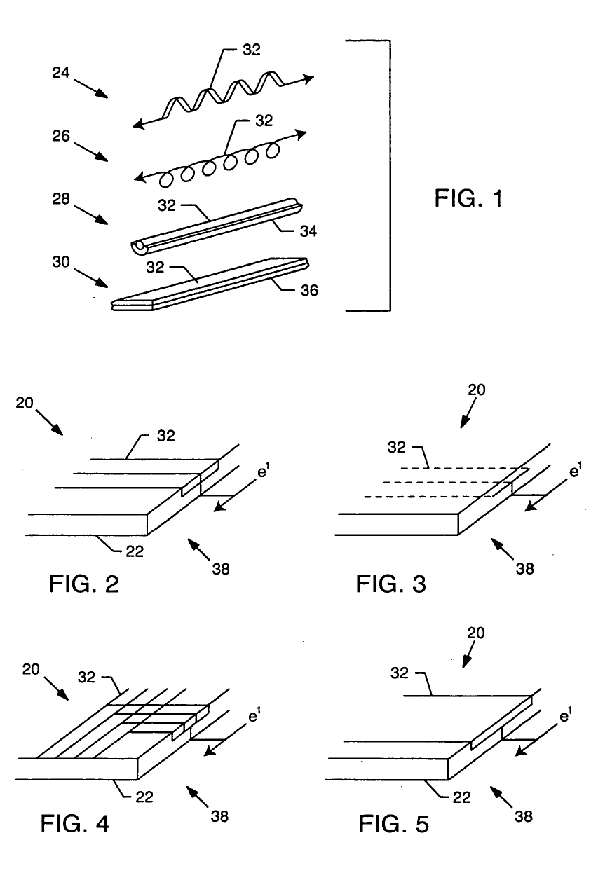

As shown in the drawings for purposes of illustration, the present invention resides in an electrical generating system into a roadway. With reference to FIGS. 1-13, various embodiments of a section of an electrical generating system 20 are shown incorporated into a roadway 22. A large number of identical sections of each of the illustrated embodiments can be incorporated into just a small length of a roadway 22. The number of sections employed depends on the electrical generating needs of the surrounding community.

FIG. 1 illustrates several forms that a wire, strip or cable incorporating piezoelectric elements can take in order to enhance deflection/stress/deformation/compression of piezoelectric elements in order to maximize generation of electrical current. The wire, strip or cable can take several forms including, without limitation, a sine wave 24, a coil 26, a compressible layer/sheath 28, and a sheet/plate 30. The compressible layer/sheath 28 form incorporates a layer of piezoelectric elements 32 situated on top of a hemispherical sheath 34. The sheet/plate 30 from incorporates a layer of piezoelectric elements 32 on top of a plate 36.

Piezoelectric elements can be incorporated into a roadway 22 either intrinsically or extrinsically. Intrinsic piezoelectric elements 32 are incorporated into the roadway 22 (i.e., under the surface of the roadway 22) or on the surface of the roadway 22 but covered by a durable cover/coating. Extrinsic piezoelectric elements 32 are exposed on the surface of a roadway 22 or in grooves/channels in the roadway 22.

As shown in FIG. 2, extrinsic piezoelectric elements 32 are incorporated into a section of roadway 22. The piezoelectric elements 32, in the form of strips or cables, are shown arranged transverse to the flow of traffic. Motor vehicles (not shown) pass over the piezoelectric elements 32. The mass of the motor vehicles deform the piezoelectric elements 32 and create electrical current that passes through a current collector e1 to another location (not shown).

Intrinsic piezoelectric elements 32 incorporated into a section of roadway 22 are illustrated in FIG. 3. The piezoelectric elements 32, in the form of strips or cables, are shown arranged transverse to the flow of traffic. Motor vehicles (not shown) pass over the piezoelectric elements 32 in the roadway 22. The mass of the motor vehicles deform the piezoelectric elements 32 and create electrical current that passes through a current collector e1 to another location (not shown).

FIG. 4 shows extrinsic piezoelectric elements 32 incorporated into a section of roadway 22. The piezoelectric elements 32, in the form of strips or cables, are shown arranged longitudinal to the flow of traffic. Motor vehicles (not shown) pass over the piezoelectric elements 32 in the roadway 22. The mass of the motor vehicles deform the piezoelectric elements 32 and create electrical current that passes through a current collector e1 to another location (not shown).

As illustrated in FIG. 5, an extrinsic piezoelectric element 32 is incorporated into a section of roadway 22. The illustrated piezoelectric element 32, in the form of a sheet, plate, coating or film, is shown arranged transverse to the flow of traffic. Motor vehicles (not shown) pass over the piezoelectric element 32. The mass of the motor vehicles deform the piezoelectric element 32 and creates electrical current that passes through a current collector e1 to another location (not shown). In the alternative, the sheet, plate, coating or film of piezoelectric elements 32 can be intrinsic (i.e., incorporated into the roadway 22 or on the surface of the roadway 22 but covered by a durable cover/coating).

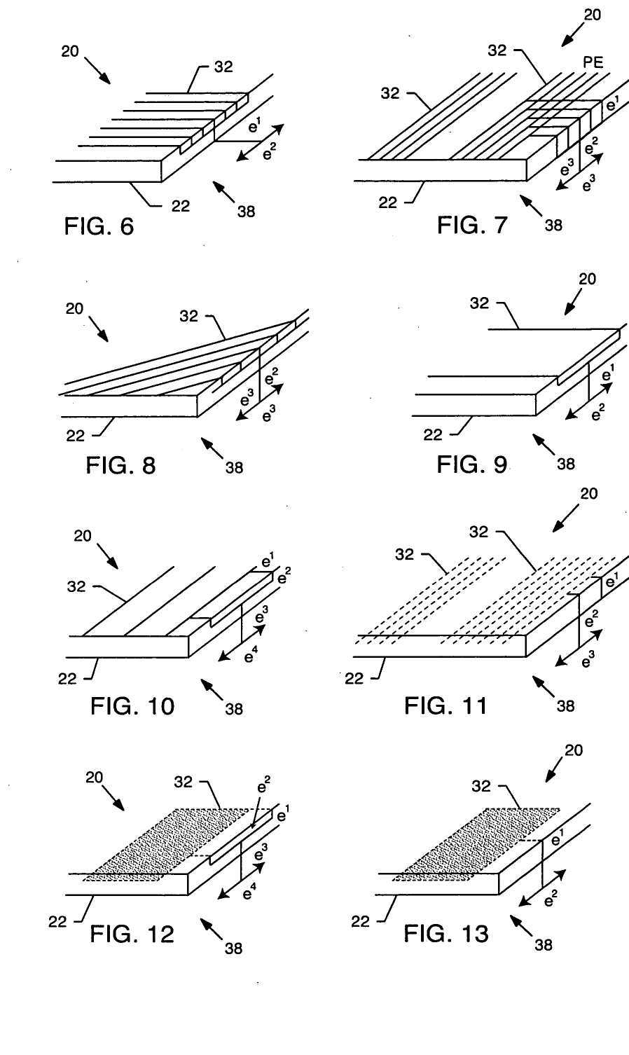

As shown in FIG. 6, extrinsic piezoelectric elements 32 are incorporated into a section of roadway 22. The piezoelectric elements 32, in the form of strips or cables, are shown arranged transverse to the flow of traffic, similar to that illustrated in FIG. 2 except that a larger number of elements 32 are used. Motor vehicles (not shown) pass over the piezoelectric elements 32. The mass of the motor vehicles deform the piezoelectric elements 32 and create electrical current that passes through current collectors e1, e2 to other locations (not shown).

FIG. 7 shows intrinsic piezoelectric elements 32 incorporated into a section of roadway 22. The piezoelectric elements 32, in the form of strips or cables, are shown arranged longitudinal to the flow of traffic, similar to that illustrated in FIG. 4 except that a larger number of elements 32 are used. Motor vehicles (not shown) pass over the piezoelectric elements 32 in the roadway 22. The mass of the motor vehicles deform the piezoelectric elements 32 and create electrical current that passes through current collectors e1, e2, e3 to other locations (not shown). In this example, another section of longitudinally arranged piezoelectric elements 32 are shown that are connected to other current collectors (not shown). Different sections of piezoelectric elements 32 may be used to provide power for different purposes and may therefore be both mechanically and electrically separate from each other.

As shown in FIG. 8, extrinsic piezoelectric elements 32 are incorporated into a section of roadway 22. The piezoelectric elements 32, in the form of strips or cables, are shown arranged diagonally to the flow of traffic on the roadway 22. Motor vehicles (not shown) pass over the piezoelectric elements 32. The mass of the motor vehicles deform the piezoelectric elements 32 and create electrical current that passes through current collectors e1, e2, e3 to other locations (not shown).

As illustrated in FIG. 9, an extrinsic piezoelectric element 32 is incorporated into a section of roadway 22. The illustrated piezoelectric element 32, in the form of a sheet or plate, is shown arranged transverse to the flow of traffic, similar to that illustrated in FIG. 5. Motor vehicles (not shown) pass over the piezoelectric element 32. The mass of the motor vehicles deform the piezoelectric element 32 and creates electrical current that passes through a current collector e1, e2 to other locations (not shown). In the alternative, the sheet or plate of piezoelectric elements 32 can be intrinsic (i.e., incorporated into the roadway 22 or on the surface of the roadway 22 but covered by a durable cover/coating).

FIG. 10 shows extrinsic piezoelectric elements 32 incorporated into a section of roadway 22. The piezoelectric elements 32, in the form of strips or cables, are shown arranged longitudinal to the flow of traffic. Motor vehicles (not shown) pass over the piezoelectric elements 32 in the roadway 22. The mass of the motor vehicles deform the piezoelectric elements 32 and create electrical current that passes through current collectors e1, e2, e3, e4 to other locations (not shown).

FIG. 11 illustrates intrinsic piezoelectric elements 32 incorporated into a section of roadway 22. The piezoelectric elements 32, in the form of a combination of strips or cables and a plate, are shown arranged longitudinal to the flow of traffic. Motor vehicles (not shown) pass over the piezoelectric elements 32 in the roadway 22. The mass of the motor vehicles deform the piezoelectric elements 32 and create electrical current that passes through current collectors e1, e2, e3 to other locations (not shown).

Intrinsic piezoelectric elements 32 are shown incorporated into a section of roadway 22 in FIG. 12. The piezoelectric elements 32 are in the form of a combination of film or layer of piezoelectric material connected to a plate. Motor vehicles (not shown) pass over the piezoelectric elements 32 in the roadway 22. The mass of the motor vehicles deform the piezoelectric elements 32 and create electrical current that passes through current collectors e1, e2, e3, e4 to other locations (not shown).

Intrinsic piezoelectric elements 32 are shown in FIG. 13 in the form of a film or layer of piezoelectric material incorporated into a section of roadway 22. Motor vehicles (not shown) pass over the piezoelectric elements 32 in the roadway 22. The mass of the motor vehicles deform the piezoelectric elements 32 and create electrical current that passes through current collectors e1, e2 to other locations (not shown).

As outlined above, the piezoelectric elements 32 are selected from a variety of types including, without limitation, wires, strips, cables (sheathed or unsheathed) or the like. These piezoelectric elements 32 are shaped to maximize their deformable surface area as the more surface area there is to be deformed, the greater the potential for generating electric current. The piezoelectric elements 32 are shaped to provide more deformable surface area than a straight piezoelectric element 32. For example, a coiled piezoelectric wire or sine wave-shaped piezoelectric wire that is stretched across the roadway 22 provides more deformable surface area than a straight piezoelectric wire that is stretched across the same width of roadway 22. Likewise, shaped piezoelectric strips, cables or the like provide more deformable surface area than straight piezoelectric strips, cables or the like.

Piezoelectric-based electrical generating systems 20, such as those illustrated in FIGS. 1-13, can also be incorporated into the construction of other roadway elements which are subject to constant and repetitive physical stresses, such as pylons and supports and their connectors to elevated structures such as elevated roadways and overpasses by embedding the systems into those roadway elements or structures. Movement of those roadway elements or structures deforms the piezoelectric elements 32 and generates electric current. For example, piezoelectric elements 32 embedded within structures that support the roadway generate electric current from the repetitive stresses upon those structures. Likewise, incorporation of piezoelectric-based generating systems, as seen in FIGS. 1-13, into the structure of very large and tall structures under continual and repetitive environmental stresses, such as might be encountered by very tall structures subject to wind buffeting and diurnal deformation and stresses resulting from temperature change, are also a source of inexpensive, renewable and significant electrical power.

Piezoelectric elements 32 can come in various forms including, without limitation, strips, wires, cable, plates, sheets, disks, rings, tubes, thin films and coatings. These strips, wires and the like may be made out of the coated with a piezoelectric film or the piezoelectric element may comprise a piezoelectric film that is used to coat the surface of the roadway.

A durable coating of piezoelectric material, such as that described below, can be applied or painted onto the surface of the roadway 22, applied to a surface of the roadway 22 that is then covered as the roadway 22 is being paved or the like, mixed into the material forming the roadway 22, or otherwise applied to the roadway 22.

As shown in FIGS. 2-13, the piezoelectric elements 32 are incorporated into a section 38 of roadway 22. This section of roadway 22 can be a conventional roadway 22 in which piezoelectric elements 32 are incorporated as the roadway 22 is being paved during original construction, as part of a repair, or as part of a retrofit. However, the section 38 may be a piezoelectric roadway segment that is separately formed from the roadway 22 and later integrated into the roadway 22 to become part of the roadway 22. In this manner, the piezoelectric roadway segment 38 is prepared with piezoelectric elements 32 and the segment 38 is then incorporated into the roadway 22 such that the segment 38 is level with the surface of the roadway 22.

Various piezoelectric materials may be used to form the piezoelectric elements 32 including, without limitation, quartz, lithium sulphate, barium titanate, lithium tantalate, lithium niobate, polyvinylidene fluoride (PVDF), lead zirconate titanate (PZT), lead titanate (PT), lead metaniobate (PbNb2O6), lead niobate, PZN-PT (combining lead with zinc, niobium, and lead-titanate), PMN-PT (combining lead with magnesium, niobium, and lead-titanate), and lead-free piezoelectric ceramic materials such as perovskite-type ferroelectrics.

Although several embodiments have been described in detail for purposes of illustration, various modifications may be made without departing from the scope and spirit of the invention. Accordingly, the invention is not to be limited, except as by the appended claims.

1. A process for generating electricity from vehicular traffic, comprising:
distributing a plurality of piezoelectric elements no higher than an adjacent surface of a roadway;
generating electric current as traffic passes over the roadway; and
conducting the electric current away from the piezoelectric elements to provide the electrical current for consumption.

2. The process of claim 1, including the step of embedding the piezoelectric elements under the surface.

3. The process of claim 1, including the step of arranging the piezoelectric elements across a flow of traffic.

4. The process of claim 1, wherein the generating step includes the step of deforming the piezoelectric elements to create the electric current.

5. The process of claim 1, wherein the generating step generates electric current without moving parts.

6. The process of claim 1, including the step of selecting the piezoelectric elements comprising wires shaped to maximize deformable surface area.

7. The process of claim 1, including the step of selecting the piezoelectric elements comprising strips shaped to maximize deformable surface area of the piezoelectric elements.

8. The process of claim 1, including the step of selecting the piezoelectric elements comprising cables shaped to maximize deformable surface area of the piezoelectric elements.

9. The process of claim 8, wherein the cables comprise sheathed cables.

10. The process of claim 1, including the step of selecting the piezoelectric elements comprising plates.

11. The process of claim 1, including the step of preparing the surface as part of a piezoelectric roadway segment.

12. The process of claim 11, including the step of incorporating the roadway segment into the roadway wherein the segment is level with the roadway.

13. The process of claim 1, including the step of coating the piezoelectric elements with a piezoelectric film.

14. The process of claim 1, wherein the piezoelectric elements comprise a piezoelectric film; and including the step of coating the surface of the roadway with the piezoelectric film.

15. The process of claim 1, including the steps of incorporating piezoelectric elements within structures supporting the roadway; and generating electric current from repetitive stresses upon the structures.

16. The process of claim 1, including the step of selecting the piezoelectric elements comprising wires shaped to provide more deformable surface area than a straight piezoelectric element.

17. The process of claim 1, including the step of selecting the piezoelectric elements comprising strips shaped to provide more deformable surface area than a straight piezoelectric element.

18. The process of claim 1, including the step of selecting the piezoelectric elements comprising cables shaped to provide more deformable surface area than a straight piezoelectric element.

19. A process for generating electricity from vehicular traffic, comprising:
distributing a plurality of piezoelectric elements no higher than an adjacent surface of a roadway;
arranging the piezoelectric elements across a flow of traffic;
generating electric current as traffic passes over the roadway;
deforming the piezoelectric elements to create the electric current; and
conducting the electric current away from the piezoelectric elements to provide the electrical current for consumption.

20. The process of claim 19, including the step of embedding the piezoelectric elements under the surface.

21. The process of claim 19, wherein the generating step generates electric current without moving parts.

22. The process of claim 19, including the step of selecting the piezoelectric elements comprising plates.

23. The process of claim 19, including the steps of preparing the surface as part of a piezoelectric roadway segment and incorporating the roadway segment into the roadway wherein the segment is level with the roadway.

24. The process of claim 19, including the step of coating the piezoelectric elements with a piezoelectric film.

25. The process of claim 19, wherein the piezoelectric elements comprise a piezoelectric film; and including the step of coating the surface of the roadway with the piezoelectric film.

26. The process of claim 19, including the steps of incorporating piezoelectric elements within structures supporting the roadway; and generating electric current from repetitive stresses upon the structures.

27. The process of claim 19, including the step of selecting the piezoelectric elements comprising wires shaped to provide more deformable surface area than a straight piezoelectric element.

28. The process of claim 19, including the step of selecting the piezoelectric elements comprising strips shaped to provide more deformable surface area than a straight piezoelectric element.

29. The process of claim 19, including the step of selecting the piezoelectric elements comprising cables shaped to provide more deformable surface area than a straight piezoelectric element.

30. A process for generating electricity from vehicular traffic, comprising:
selecting a plurality of piezoelectric elements shaped to provide more deformable surface area than a straight piezoelectric element;
distributing the piezoelectric elements no higher than an adjacent surface of a roadway;
arranging the piezoelectric elements across a flow of traffic;
embedding the piezoelectric elements under the surface;
generating electric current as traffic passes over the roadway;
deforming the piezoelectric elements to create the electric current; and
conducting the electric current away from the piezoelectric elements to provide the electrical current for consumption;
wherein the generating step generates electric current without moving parts.

31. The process of claim 30, including the steps of preparing the surface as part of a piezoelectric roadway segment and incorporating the roadway segment into the roadway wherein the segment is level with the roadway.

32. The process of claim 30, including the steps of incorporating piezoelectric elements within structures supporting the roadway; and generating electric current from repetitive stresses upon the structures.
